(19) United States
(12) Patent Application Publication
(10) Pub. No.: US 2024/0402339 A1
(43) Pub. Date: Dec. 5, 2024

(54) DISTANCE MEASURING DEVICE AND DISTANCE MEASURING SYSTEM

(71) Applicant: Sony Semiconductor Solutions Corporation, Atsugi-shi, Kanagawa (JP)

(72) Inventor: Haruhiko TERADA, Kanagawa (JP)

(73) Assignee: Sony Semiconductor Solutions Corporation, Atsugi-shi, Kanagawa (JP)

(21) Appl. No.: 18/690,752

(22) PCT Filed: Mar. 11, 2022
(86) PCT No.: PCT/JP2022/010848

§ 371 Date: Mar. 11, 2024

(30) Foreign Application Priority Data
Sep. 30, 2021 (JP) 2021-160952

(51) Int. Cl. G01S 17/32; G01S 7/48; G01S 7/481

(52) U.S. Cl. CPC G01S 17/32; G01S 7/4802; G01S 7/4816; G01S 7/4817

(57) ABSTRACT

The present disclosure relates to a distance measuring device and a distance measuring system that can suppress crosstalk between channels. Provided is a distance measuring device including a photonic integrated circuit that has a function compatible with a coherent LiDAR method that measures distance based on interference between reception light, which is reflected light of transmission light irradiated on a target, and reference light. The photonic integrated circuit independently includes a first coupler for the transmission light and a second coupler for the reference light as optical couplers that couple the inside and outside of an optical waveguide. The present disclosure can be applied to a distance measuring device that measures distance using a coherent LiDAR method.

### TECHNICAL FIELD

The present disclosure relates to a distance measuring device and a distance measuring system, and particularly relates to a distance measuring device and a distance measuring system that can suppress crosstalk between channels.

### BACKGROUND ART

LiDAR (Light Detection and Ranging) is a distance measurement technology based on measurement of scattered light in response to laser irradiation, and is applied to various applications including automated driving. Several LiDAR measurement methods have been proposed, and in particular, a method that uses an optical interferometer to detect the difference frequency between reception light and reference light and measure distance is called coherent LiDAR. So-called FMCW (Frequency Modulated Continuous Wave) LiDAR is a type of coherent LiDAR.

When automated driving or the like is performed on expressways, it is necessary to measure distance within the field of view at high resolution and high frame rate so that small obstacles in the distance can be detected quickly and avoided safely. That is, it is required to increase the point rate, which is the number of distance measurement points per unit time. To obtain a high point rate, it is necessary to increase the number of simultaneous LiDAR measurement points, that is, the number of channels.

For example, PTL 1 discloses a technology related to multi-channel coherent LiDAR having a large number of channels. PTL 1 discloses a multi-channel coherent LiDAR in which a light source is configured with a photonic integrated circuit (PIC) and an optical interferometer is configured with discrete optical elements.

### CITATION LIST

### Patent Literature

### [PTL 1]

U.S. Patent Application Publication No. 2021/0018598 (Specification)

### SUMMARY

### Technical Problem

Multi-channel coherent LiDAR, which has a large number of channels, is required to suppress crosstalk (interference) between channels. In the multi-channel coherent LiDAR disclosed in PTL 1, countermeasures against crosstalk are not sufficient, and there is a risk that a target that does not actually exist may be detected by mistake.

The present disclosure has been devised in view of such circumstances and is intended to suppress crosstalk between channels.

### Solution to Problem

A distance measuring device according to an aspect of the present disclosure includes a photonic integrated circuit that has a function compatible with a coherent LiDAR method that measures distance based on interference between reception light, which is reflected light of transmission light irradiated on a target, and reference light, wherein the photonic integrated circuit independently includes a first coupler for the transmission light and a second coupler for the reference light as optical couplers that couple the inside and outside of an optical waveguide.

A distance measuring system according to one aspect of the present disclosure includes a photonic integrated circuit that has a function compatible with a coherent LiDAR method that measures distance based on interference between reception light, which is reflected light of transmission light irradiated on a target, and reference light; and an external optical system including a telescope that deflects the transmission light to different emission angles for each pixel and a scanner that can deflect the transmission light from the telescope at least in a direction that intersects an arrangement direction of pixels, wherein the photonic integrated circuit independently includes a first coupler for the transmission light and a second coupler for the reference light as optical couplers that couple the inside and outside of an optical waveguide.

The distance measuring device and the distance measuring system according to one aspect of the present disclosure are provided with a photonic integrated circuit that has a function compatible with a coherent LiDAR method that measures distance based on interference between reception light, which is reflected light of transmission light irradiated on a target, and reference light Further, the photonic integrated circuit is provided with a first coupler for the transmission light and a second coupler for the reference light independently as optical couplers that couple the inside and outside of an optical waveguide.

Note that the distance measuring device according to one aspect of the present disclosure may be an independent device or may be an internal block forming one device.

### BRIEF DESCRIPTION OF DRAWINGS

FIG. 1 is a cross-sectional view showing a configuration example of a distance measuring device to which the present disclosure is applied.

FIG. 2 is a top view showing an example of the configuration of the distance measuring device shown in FIG. 1.

FIG. 3 is a top view showing an example of the configuration of a microlens array shown in FIG. 1.

FIG. 4 is a diagram showing a first example of the layout of a TX-PIC.

FIG. 5 is a diagram showing a configuration example of an optical switch or a modulator.

FIG. 6 is a diagram showing an example of the configuration of a grating coupler.

FIG. 7 is a graph for explaining a specific example of distance measurement and velocity measurement.

FIG. 8 is a diagram showing a second example of the layout of the TX-PIC.

FIG. 9 is a diagram showing a first example of an emission pattern of TX-PIC.

FIG. 10 is a diagram showing a second example of an emission pattern of TX-PIC.

FIG. 11 is a diagram showing a third example of an emission pattern of TX-PIC.

FIG. 12 is a block diagram showing a configuration example of a distance measuring system to which the present disclosure is applied.

FIG. 13 is a diagram showing an example of target scanning.

FIG. 14 is a flowchart illustrating the flow of operation of the distance measuring system.

FIG. 15 is a cross-sectional view showing another configuration example of a distance measuring device to which the present disclosure is applied.

FIG. 16 is a top view showing a configuration example of the distance measuring device shown in FIG. 15.

FIG. 17 is a top view showing a configuration example of a microlens array shown in FIG. 15.

### DESCRIPTION OF EMBODIMENTS

### 1. Embodiment of Present Disclosure

### (System Configuration)

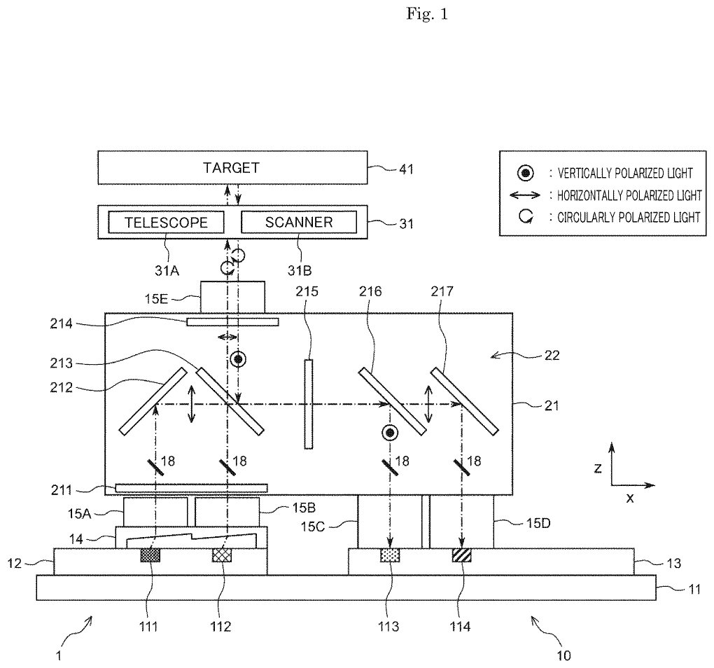

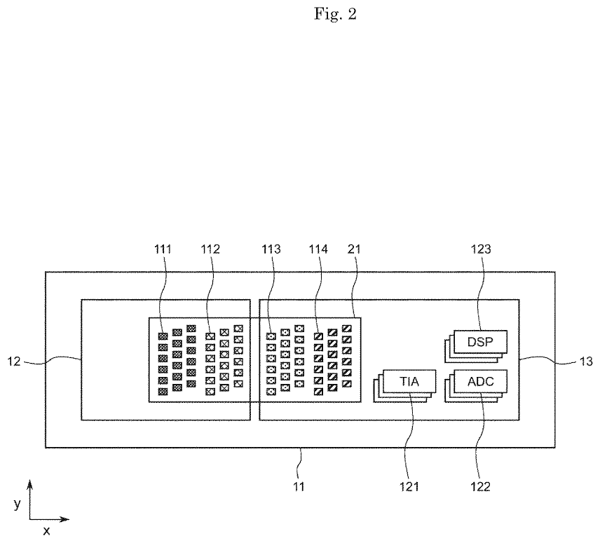

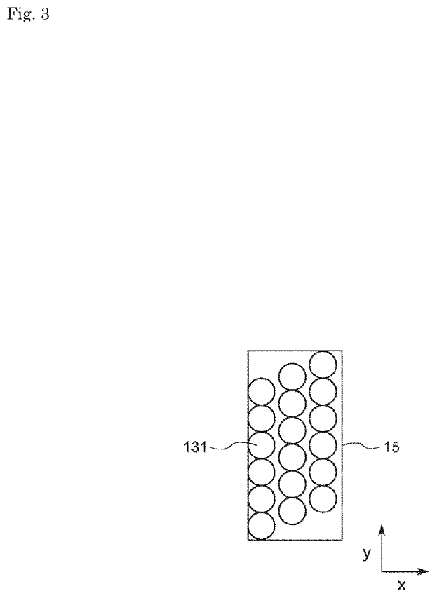

A configuration example of a distance measuring system to which the present disclosure is applied will be described with reference to FIGS. 1 to 3. FIG. 1 is a cross-sectional view showing a configuration example of a distance measuring device 10 to which the present disclosure is applied. FIG. 2 is a top view showing a configuration example of the distance measuring device 10 of FIG. 1. FIG. 3 is a top view showing an example of a configuration of the microlens array 15 in FIG. 1.

In FIG. 1, a distance measuring system 1 includes the distance measuring device 10 and an external optical system 31. The distance measuring device 10 is configured as a coherent LiDAR module that supports multi-channels. In the distance measuring device 10, two IC chips, a TX-PIC 12 and an RX-IC 13, are mounted on a package substrate 11.

The TX-PIC 12 is a photonic integrated circuit (PIC) in which an optical waveguide is formed on a semiconductor substrate using semiconductor lithography technology, and various functional optical elements are integrated on a single chip depending on the material composition and pattern shape. The TX-PIC 12 generates transmission light (TX light) and reference light (LO light) for coherent LiDAR.

Examples of methods for emitting light from a photonic integrated circuit include an edge coupler (EC) for emitting light from the end face of the chip, and a grating coupler (GC) for emitting light from the chip surface. In the TX-PIC 12, it is preferable to use a grating coupler that has a high degree of freedom in arranging the emission position, and in the following description, a case where a grating coupler is used will be exemplified.

The TX-PIC 12 has eighteen LO GCs 111 that emit reference light and eighteen TX GCs 112 that emit transmission light. As shown in the top view of FIG. 2, six LO GCs 111 and six TX GCs 112 can be arranged in each row with an offset of three rows. The optical waveguide of the TX-PIC 12 is made of silicon (Si), and the center wavelength of the transmission light can be 1550 nm, but is not limited to this.

The RX-IC 13 is a semiconductor integrated circuit having a differential photodetector (PD) for each pixel, and is configured as a receiving circuit. A differential photodetector (hereinafter referred to as a differential PD) is an element that connects two photodiodes (PD) with matched characteristics in series and outputs a difference in photocurrent. Hereinafter, the two photodiodes will also be referred to as lower PD 113 and upper PD 114. As shown in the top view of FIG. 2, six lower PDs 113 and six upper PDs 114 can be arranged in each row with an offset of three rows.

The RX-IC 13 also includes a TIA (Transimpedance Amplifier) 121, an ADC (Analog-to-Digital Converter) 122, and a DSP (Digital Signal Processor) 123, as shown in the top view of FIG. 2. A plurality of TIAs 121, ADCs 122, and DSPs 123 can each be provided. The TIA 121 converts the output current waveform of the differential PD into a voltage waveform. The ADC 122 converts the output of the TIA 121, which is an analog voltage waveform, into a digital output. The DSP 123 performs digital signal processing based on the output of the ADC 122 and extracts target information corresponding to each pixel.

The target information is information such as the frequency spectrum of the received signal, the peak detection result of the spectrum, or target distance/velocity information based on the peak detection result. For example, when the center wavelength of the transmission light is 1550 nm, the differential PD mounted on the RX-IC 13 is required to have high sensitivity at 1550 nm. Differential PDs can be made using so-called Ge-on-Si, in which germanium crystals are grown on silicon substrates, or a compound semiconductor containing elements such as indium (In), phosphorus (P), gallium (Ga), arsenic (As), and germanium (Ge).

On the other hand, the circuit elements of the RX-IC 13 other than the differential PD such as the TIA 121 and the ADC 122 differ from differential PDs in the degree of required microfabrication (minimum line width or the like) and optimal annealing temperature. From the viewpoint of performance and cost, it is preferable to manufacture the device on a separate wafer using an advanced CMOS (Complementary Metal Oxide Semiconductor) process.

Specifically, in the case of Ge-on-Si PDs, the RX-IC 13 can be manufactured by bonding a silicon wafer on which PDs and electrodes are formed and a CMOS wafer containing circuit elements other than PDs using a wafer-to-wafer bonding process. In addition, in the case of a compound semiconductor PD, the RX-IC 13 may be manufactured by manufacturing only the PD itself or a PD array using a compound semiconductor, dicing it, and bonding it to an Si CMOS using a die-to-wafer bonding process.

It is preferable that the number of pixels and the pixel pitch of the differential PDs on the RX-IC 13 be the same as those of the TX-PIC 12. Specifically, as shown in the top view of FIG. 2, each pixel can be arranged in a corresponding manner by arranging six LO GCs 111 and six TX GCs 112 of the TX-PIC 12 and six lower PDs 113 and six upper PDs 114 of the RX-IC 13 in each row with an offset of three rows.

That is, the lower PD 113 and upper PD 114, which are the pixels of the RX-IC 13, can be arranged at the same Y coordinates as the LO GC 111 and TX GC 112, which are the pixels of the TX-PIC 12, respectively. This allows the emitted light from the grating coupler (GC) and the reflected light from the target 41 to be received by the differential PD corresponding to each pixel.

Although the output angle of the grating coupler depends on the design of the grating coupler, it generally has an inclination of about 10° from the vertical direction with respect to the PIC substrate of the TX-PIC 12. A wedge prism (WeP) 14 may be provided on the TX-PIC 12 in order to correct this inclination in the vertical direction and make the light incident on an optical interferometer block 21.

Furthermore, a micro lens array (MLA) 15 may be provided on a wedge prism 14. As shown in the top view of FIG. 3, the microlens array 15 is an optical element having a plurality of microlenses 131 corresponding to the number of pixels. Microlens arrays 15A and 15B are arranged in accordance with the pitch of the grating couplers so that one microlens 131 covers the pixels of the LO GC 111 and the TX GC 112. The light emitted from the grating coupler usually has a predetermined spread angle (for example, 20°), but since the microlens arrays 15A and 15B act as collimators, the light is converted into parallel light (collimated light) when it enters the optical interferometer block 21.

Microlens arrays 15C and 15D may also be provided on the RX-IC 13. Here, the microlens arrays 15C and 15D work to condense the collimated light incident from the optical interferometer block 21 and make it efficiently enter the lower PD 113 and the upper PD 114.

In the distance measuring device 10, the optical interferometer block 21 is attached so as to straddle the TX-PIC 12 and the RX-IC 13. As shown in the cross-sectional view of FIG. 1, the optical interferometer block 21 is an optical block that includes half wave plates (HWP) 211 and 215, quarter wave plates (QWP) 214, total reflection mirrors 212 and 217, and polarizing beam splitters 213 and 216.

A slight deviation (several tens of nanometers) in each optical path length within the optical interferometer block 21 can affect reception sensitivity. Considering the influence of thermal expansion or the like, it is preferable to design the optical interferometer block 21 as small as possible and shorten the absolute value of the optical path length. Furthermore, it is preferable to avoid displacement of the arrangement of each element within the distance measuring device 10 due to vibration as much as possible.

Therefore, as shown in the top view of FIG. 2, it is preferable to arrange the pixel portions of the TX-PIC 12 and the RX-IC 13 close to each other, and fix the optical interferometer block 21 so as to straddle them. In order to securely fix each optical element in the optical interferometer block 21, it is preferable that the inside of the optical interferometer block 21 be filled with a transparent optical material that transmits the wavelength of the transmission light. Specifically, as shown in the cross-sectional view of FIG. 1, in the optical interferometer block 21, the gaps 22 between the plurality of optical elements including the half wave plates 211 and 215, the quarter wave plate 214, the total reflection mirrors 212 and 217, and the polarizing beam splitter 213 and 216 can be filled with an optical material, such as, for example, glass or optical plastic.

As shown in the cross-sectional view of FIG. 1, the half wave plates 211 and 215 and the quarter wave plate 214 can be arranged so that the incident light beam (collimated light) is perpendicularly incident thereon. The total reflection mirrors 212 and 217 and the polarizing beam splitters 213 and 216 can be arranged at an angle of 45° with respect to the incident light beam.

The emitted light from the LO GC 111 and the TX GC 112 is polarized in a direction perpendicular to the plane of the paper in the cross-sectional view of FIG. 1, and the light passes through the half wave plate 211 provided at the incidence position of the optical interferometer block 21, whereby the light becomes polarized horizontally to the plane of the paper (horizontally polarized light).

The light incident on the optical interferometer block 21 from the TX GC 112 passes through the polarizing beam splitter 213 and further passes through the quarter wave plate 214, where the horizontally polarized light is converted into circularly polarized light, and the light is output from the optical interferometer block 21.

A microlens array 15E may be further provided above the optical interferometer block 21. The microlens array 15E converts transmission light from collimated light into light having a predetermined spread angle. The transmission light that has passed through the microlens array 15E is irradiated onto the target 41 via the external optical system 31.

The transmission light is reflected by the target 41, passes through the external optical system 31 as reception light (RX light), enters the microlens array 15E as convergent light, is collimated by the microlens array 15E, and enters the optical interferometer block 21. When the transmission light is circularly polarized light, assuming specular reflection by the target 41, the reception light will also be circularly polarized light. Therefore, the reception light is converted into vertically polarized light by passing through the quarter wave plate 214.

Next, the reception light is reflected by the polarizing beam splitter 213 and travels to the right in the paper of FIG. 1, and is simultaneously mixed with reference light (horizontally polarized light) that enters the polarizing beam splitter 213 from the left in the paper. This mixed light passes through the half wave plate 215 and then enters the polarizing beam splitter 216 to separate it into a vertically polarized component and a horizontally polarized component. By making the separated vertically polarized light component and horizontally polarized light component enter the upper PD 114 and the lower PD 113, respectively, the difference frequency between the reference light and the reception light can be extracted as the output of the differential PD.

In the distance measuring device 10, in order to realize desired signal detection, the optical axes of the half wave plates 211 and 215 and the quarter wave plate 214 in the optical interferometer block 21 need to be adjusted to a predetermined inclination. For example, the optical axis of the half wave plate 215 into which the mixed light of the reference light and the reception light is incident can preferably be adjusted to an azimuth angle of 22.5°.

The external optical system 31 includes a telescope 31A and a scanner 31B. The telescope 31A is an optical system that re-collimates the transmission light that enters from the distance measuring device 10 with a spread angle and deflects it to a different emission angle for each pixel. As this optical system, for example, a single convex lens spanning eighteen pixels can be used. The scanner 31B is an optical deflection device that can deflect at least the transmission light from the telescope 31A in a direction intersecting the pixel arrangement direction. Although the direction in which the scanner 31B can deflect light is not particularly limited, it can typically be a direction perpendicular to the pixel arrangement direction.

The scanner 31B can be configured as a mechanical scanning device such as a polygon mirror, a voice coil mirror, a galvano mirror, a MEMS (Micro Electro Mechanical Systems) mirror, or a Risley prism. Alternatively, a so-called head spin type scanner in which the distance measuring device 10 itself configured as a LiDAR module is installed on a rotary table to realize mechanical scanning may be used. Alternatively, a solid state scanner using liquid crystal or a diffractive optical element (DOE) may be used.

In the distance measuring system 1, a 2D field of view (FoV) is scanned by a combination of a pixel portion (pixel array) included in the distance measuring device 10 and the scanner 31B included in the external optical system 31. In this way, a distance point group (3D point cloud) in 3D space can be obtained from the distance measurement information obtained for each point.

### (Tx-Pic Configuration)

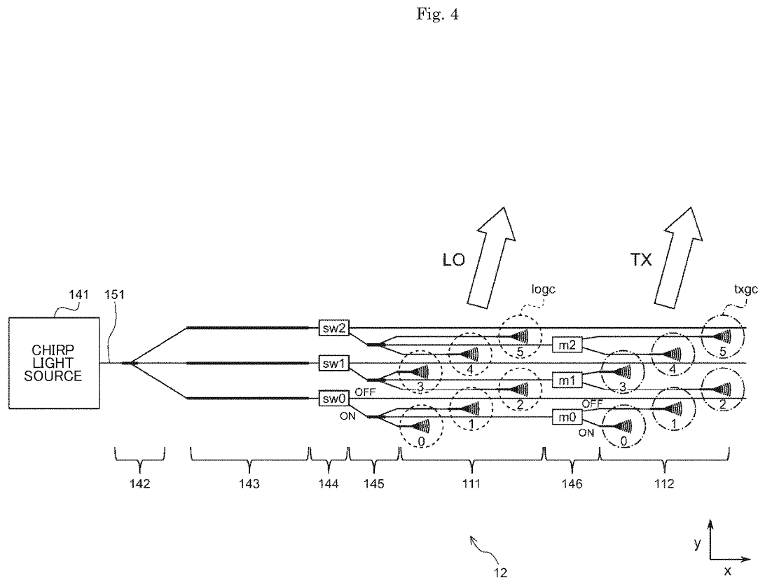

FIG. 4 is a diagram showing a first example of the layout of the TX-PIC 12 in FIG. 1. In the TX-PIC 12 in FIG. 4, a layout is shown in which each of the LO GC 111 and the TX GC 112 has six pixels.

Note that in FIG. 4, logc represented by a broken line circle represents the beam diameter of the LO GC 111, and each pixel is identified by a number from 0 to 5. Furthermore, txgc represented by a dot-dashed circle represents the beam diameter of the TX GC 112, and each pixel is identified by a number from 0 to 5. In FIG. 4, a solid line connecting each element indicates an optical waveguide 151. The optical waveguide 151 is typically made of silicon, but is not limited thereto, and for example, silicon nitride (Si₃N₄) or the like may be used.

In FIG. 4, the TX-PIC 12 has a chirp light source 141. The chirp light source 141 is a narrow linewidth laser light source that can sweep the optical frequency linearly over time (this is called chirp).

Although not shown, the chirp light source 141 is realized, for example, by including an optical phase locked loop circuit (OPLL) in which a distributed feedback (DFB) laser including a compound semiconductor, or a distributed Bragg reflector (DBR) laser, a delay line and an optical interferometer using an optical waveguide, and a photodiode are mounted on the TX-PIC 12 so that a narrow linewidth of the light source is maintained and highly linear chirp is realized. As the photodiode, for example, a Ge-on-Si PD in which germanium crystal is grown on a silicon substrate can be used.

The optical output of the chirp light source 141 is input to the splitter 142, and the optical power is distributed to the three optical waveguides 151. Next, the optical power is amplified by a semiconductor optical amplifier (SOA) 143. The semiconductor optical amplifier 143 has a gain region and electrodes made of, for example, a compound semiconductor, and can amplify the incident optical power while maintaining the optical frequency (chirp waveform) according to the current injected through the electrodes.

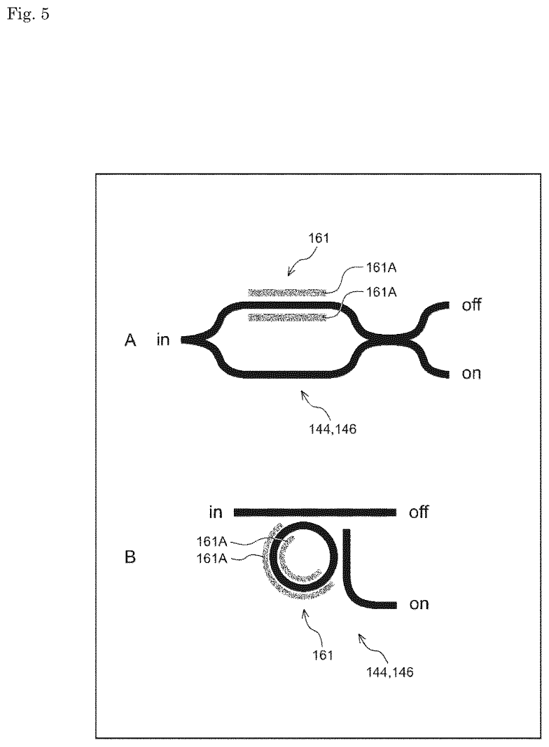

Next, the optical switch 144 controls the emission and extinction of the LO GC 111 of each pixel. As shown in FIGS. 5A and 5B, the optical switch 144 has a waveguide structure having a phase shifter 161, and changes the phase of light by applying an electric field or current to the waveguide through an electrode 161A. Depending on the magnitude of the electric field or current, the optical switch 144 can select whether to set the switch to an on state in which light incident on the in port is guided to the on port, or an off state in which light incident on the in port is guided to the off port.

The method shown in FIG. 5A is called a Mach-Zehnder type, and the method shown in FIG. 5B is called a micro-ring type, and either method may be used. The phase shifter 161 includes various types of phase shifters, such as a TO (Thermo Optic) phase shifter that utilizes the thermo-optic effect of a heater, and an EO (Electro Optic) phase shifter that utilizes an electro-optic effect such as a change in carrier density due to the electric field of a PN junction, and either method may be used.

Here, each of the three optical switches 144 is called sw0, sw1, and sw2. For example, when sw0 is on, the light is split into three by the LO splitter 145, and logc 0 and logc 1 of the LO GC 111 emit light. One of the three branches is guided to modulator 146. Intensity modulation, phase modulation, and the like can be used as optical modulation that can be integrated into the TX-PIC 12, but on-off keying (OOK) will be described here as the simplest case of intensity modulation.

When the three modulators 146 are respectively referred to as m0, m1, and m2, either txgc0 or txgc1 of the TX GC 112 emits light depending on whether m0 is turned on or off, for example. For example, when txgc0 emits light according to code (0101), txgc1 emits light according to its complementary code, code (1010).

The modulator 146 is realized using a phase shifter like the optical switch 144, and can use the structure shown in FIG. 5, for example. However, since the modulator 146 needs to be turned on and off at shorter intervals than the optical switch 144 and requires a higher response speed, it is preferable to use an EO phase shifter rather than a TO phase shifter.

In addition, by controlling the phase shift in a multi-value or analog manner instead of a simple on/off binary manner, the distribution of light intensity between adjacent grating couplers (GC), such as 10%:90%, 20%:80%) may be changed.

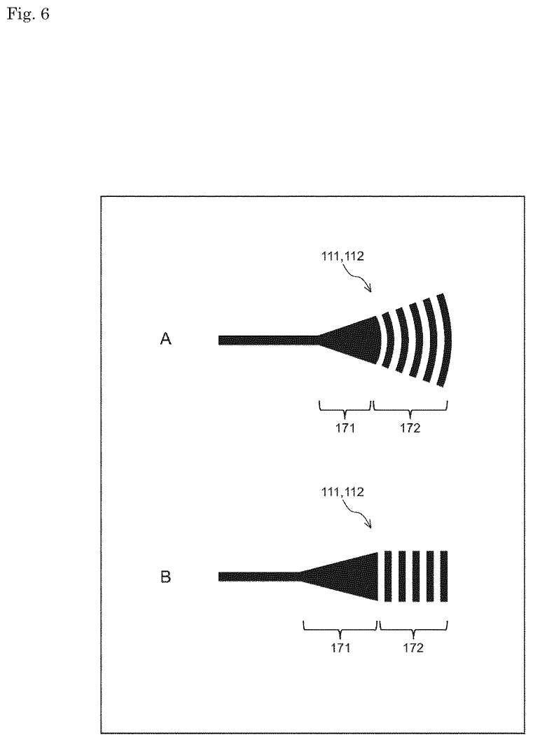

The LO GC 111 and the TX GC 112 are realized by a layout as shown in FIG. 6. That is, the LO GC 111 and the TX GC 112 have a structure in which the width of the waveguide is gradually widened by a tapered portion 171 and is connected to the grating coupler 172.

The grating coupler 172 is an optical element that has a so-called grating structure in which periodic slits are provided in a waveguide, and that radiates light from the waveguide into space in the direction of the surface of the TX-PIC 12. The grating coupler 172 may have a structure with curved slits as shown in FIG. 6A, or may have a straight slit structure as shown in FIG. 6B.

In FIG. 4, in the LO GC 111 and the TX GC 112, grating couplers corresponding to each pixel are arranged with an offset of three rows. Although the number of rows is not limited, by arranging the grating couplers with an offset of N rows (N: an integer of 2 or more), the beam diameter emitted from the grating couplers (the beam diameter represented by the broken line circles or the dot-dashed circle in FIG. 4) can be expanded up to N times without overlapping each other compared to a simple one-row arrangement. When the beam is narrow, the beam diameter tends to widen due to optical diffraction limits and non-idealities of optical components (interferometers, microlens arrays, and the like). Thus, it is preferable to arrange them with an offset of multiple rows.

### (Specific Example of Distance Measurement/Velocity Measurement)

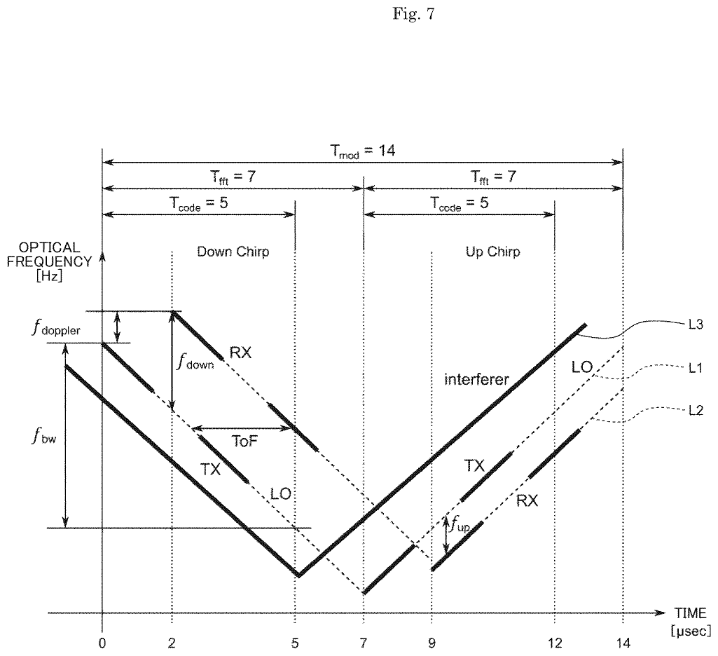

Next, with reference to FIG. 7, a specific example of distance measurement and velocity measurement in the distance measuring device 10 of FIG. 1 will be described. FIG. 7 shows the relationship between transmission light and reception light, where the vertical axis is optical frequency [Hz] and the horizontal axis is time [μsec]. In FIG. 7, a triangular wave L1 indicates transmission light (TX light) or reference light (LO light), and a triangular wave L2 indicates reception light (RX light). In the triangular waves L1 and L2, the emission section is represented by a thick line, and the extinction section is represented by a broken line. Further, the triangular wave L3 indicates interference light (interferer).

In this specific example, on-off modulation is used as modulation within the chirp, and an example of encoded transmission light (code length 4, code (1010)) in txgc0 will be explained. In FIG. 7, the measurement interval T_{mod} at one point is 14 ρsec, and the optical frequency is lowered in the first half (0 to 7 μsec) to create Down Chirp, and raised in the latter half (7 to 14 μsec) to create Up Chirp.

For example, in the distance measuring device 10, when the maximum target distance to be detected is 300 m, the time of flight (ToF: Time of Flight) of light between the distance measuring device 10 and the target 41 is 2 μsec at the maximum. In order to detect the difference frequency (Fbeat) by causing the reception light, which is received with a delay of up to 2 μsec with respect to the transmission light, to interfere with the reference light (LO light) generated from the same light source as the transmission light, 5 μsec excluding the last 2 μsec of each period (7 μsec) of the down chirp and up chirp becomes the valid period T_{code} of the transmission light. However, the reference light has the same optical frequency as the transmission light, except that there is no extinction section.

Here, as shown in FIG. 4, the TX-PIC 12 can control the emission pattern by controlling the modulators 146, which are m0, m1, and m2, using codes unique to each of the six pixels. To give a specific example, using on-off modulation (OOK) where the code length is 4, code 0 is extinction and code 1 is emission, the valid period T_{code} is divided into four time intervals of 1.25 μsec, and the emission pattern is controlled as follows: txgc0=(1010), txgc1=(0101), txgc2=(1001), txgc3=(0110), txgc4=(1100), and txgc5=(0011).

The reception light corresponding to the encoded transmission light is mixed with the reference light in the optical interferometer block 21 (FIG. 1), passes through the differential PD, the TIA 121, and the like in the RX-IC 13 (FIG. 1), and is subjected to spectrum analysis by the DSP 123. At this time, by using the entire chirp period as an FFT window (T_{fft}=7 μsec) and detecting the peaks of the frequency spectrum, the ToF can be calculated by Equations (1) and (2) using the frequencies of each detected peak.

$$\begin{matrix}[ Math . 1 ] & \\ {f}_{down} + {f}_{up} = \frac{2 {f}_{bw} ToF}{{T}_{code}} = \frac{4 {f}_{bw} R}{c {T}_{code}} & ( 1 )\end{matrix}$$

$$\begin{matrix}[ Math . 2 ] & \\ {f}_{down} - {f}_{up} = {f}_{doppler} = \frac{2 v}{{λ}_{laser}} & ( 2 )\end{matrix}$$

Note that in Equation (1), f_{down} indicates the difference frequency in the down chirp, fᵤₚ indicates the difference frequency in the up chirp, and f_{low} indicates the frequency bandwidth corresponding to the valid period T_{code}. Further, R indicates the distance from the distance measuring system 1 (distance measuring device 10) to the target 41 to be measured, and C indicates the speed of light [m/s]. In Equation (2), v represents the relative velocity [m/s] between the distance measuring system 1 (range measuring device 10) and the target 41, and λₗₐₛₑᵣ represents the center wavelength [nm] of the light source. f_{doppler} can be expressed as f_{doppler}=(v/c)fₗₐₛₑᵣ, and from these relationships, the relationship in Equation (2) is derived.

Based on the ToF and sign calculated in this way, the emission section and extinction section of the reception light are calculated, and it is confirmed that the peak frequency is not detected in the extinction section of the reception light (the spectral intensity is equal to or lower than a predetermined value). If the peak frequency is also detected in the extinction section of the reception light, it is considered that the peak frequency is due to the interference light indicated by the triangular wave L3. Here, interference light refers to, for example, light irradiated from another distance measuring device (another LiDAR module), or light that enters other pixels of the same distance measuring device 10 (same LiDAR module) through so-called multipath, in which transmission light from the other pixels is repeatedly reflected from a plurality of targets.

By using the modulation method described above, the TX-PIC 12 shown in FIG. 4 can operate six pixels in parallel per measurement period (T_{mod} in FIG. 7), and emit a transmission pulse train (TX pulse train) in which each pixel is uniquely encoded. As shown in FIG. 4, since light is alternately emitted from adjacent pixels to create complementary codes, the numbers of semiconductor optical amplifiers 143, optical switches 144, and modulators 146 required for parallel operation of six pixels are three each, which is smaller than the number of pixels. Thus, a structure that is advantageous for cost reduction is achieved.

### (Extended Configuration)

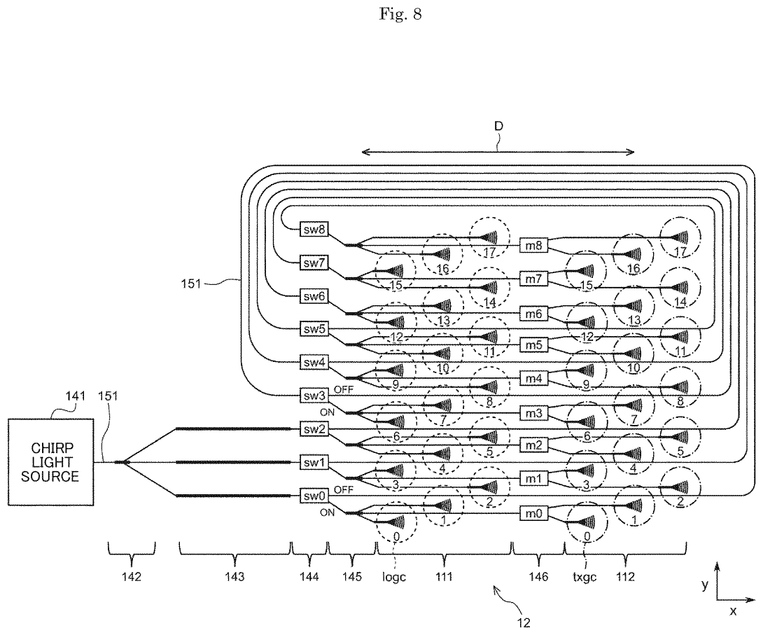

FIG. 8 is a diagram showing a second example of the layout of the TX-PIC 12 in FIG. 1. In the layout of FIG. 8, compared to the layout of FIG. 4, the number of pixels in the LO GC 111 and TX GC 112 has increased from six to eighteen pixels, but the number of semiconductor optical amplifiers 143 remains the same at three, and the number of pixels is expanded by looping the optical waveguide 151 connected to the off port of the optical switch 144.

For example, by turning off sw0 and turning on sw3 of the optical switches 144, logc6 and logc7 of the LO GC 111 and txgc6 and txgc7 of the TX GC 112 can be caused to emit light.

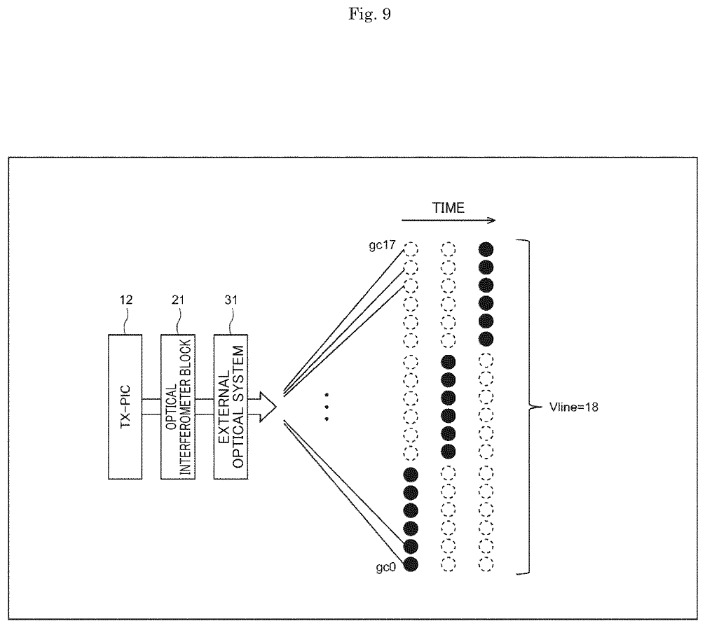

Here, an example of the emission pattern of the TX-PIC 12 in FIG. 8 will be described with reference to FIGS. 9 to 11. Note that a direction D indicated by a bidirectional arrow in FIG. 8 indicates a scanning direction by the scanner 31B of the external optical system 31. The TX-PIC 12 in FIG. 8 can operate up to six pixels in parallel among eighteen pixels. Therefore, when obtaining the maximum field of view of the distance measuring device 10, as shown in FIG. 9, eighteen scanning lines are obtained in three cycles in the order of gc0 to gc5, gc6 to gc11, and gc12 to gc17, with the right direction of the paper as the time direction.

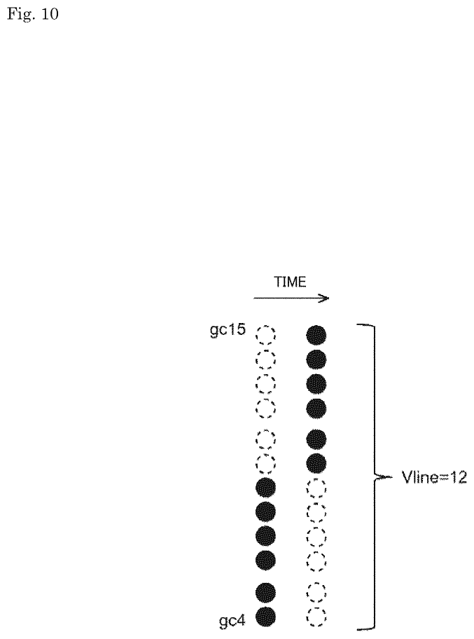

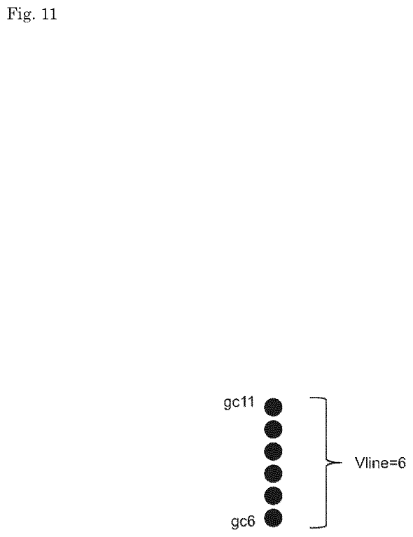

On the other hand, when concentrating the field of view of the distance measuring device 10 in the center, for example, in the range of gc4 to gc15, as shown in FIG. 10, twelve scanning lines are obtained in two cycles in the order of gc4 to gc9 and gc10 to gc15, with the right direction of the paper as the time direction. The field of view is further narrowed down, and as shown in FIG. 11, for example, in the range of gc6 to gc11, six scanning lines are obtained in one cycle.

In this way, the TX-PIC 12 shown in FIG. 8 has a characteristic layout structure in which the optical waveguide 151 is looped, so that six arbitrary consecutive grating couplers (GCs) starting from an even-numbered grating coupler can be operated in parallel. In other words, even if the field of view is narrowed down to a certain range, the measurement can be completed in fewer cycles, so unlike the technique disclosed in PTL 1 mentioned above, there is no drop in point rate or the degree of drop is reduced.

As described above, the distance measuring device 10 includes the TX-PIC 12 that has a function compatible with the coherent LiDAR method that measures distance based on interference between reception light and reference light. The TX-PIC 12 independently includes a TX GC 112 for transmission light and an LO GC 111 for reference light as optical couplers that couple the inside and outside of the optical waveguide 151. In other words, in order to suppress crosstalk (interference) with other distance measuring devices (other LiDAR modules) or other pixels of the distance measuring device 10, even when the transmission light is encoded, since the reference light is an independent port, the reference light can be emitted continuously without being encoded. As a result, the reception light can be reliably detected using the reference light. Further, in the distance measuring device 10, since the TX-PIC 12 includes a modulator 146 that modulates the transmission light, countermeasures against crosstalk can be taken by encoding the transmission light.

In the TX-PIC 12, at least some of the optical couplers of the TX GC 112 and the LO GC 111 can be grating couplers. Compared to edge couplers, grating couplers can be arranged anywhere within the TX-PIC 12 and have a higher degree of freedom in arrangement. Thus, grating couplers are suitable for realizing a structure in which the optical waveguide 151 is looped as shown in FIG. 8, for example. As a result, the TX-PIC 12 includes a structure (the structure shown in FIG. 8) in which a plurality of grating couplers arranged in a row are connected by a spiral optical waveguide 151. With this loop structure, when 2n arbitrary consecutive grating couplers (n: an integer of 1 or more) starting from an even-numbered grating coupler are operated in parallel and the field of view is narrowed down as shown in FIGS. 9 to 11, measurement can be completed in a few cycles, and a decrease in point rate can be suppressed.

In addition to the TX-PIC 12, the distance measuring device 10 further includes the optical interferometer block 21 that causes interference between the reception light and the reference light, and the RX-IC 13 that receives the interfered reception light and reference light. The optical interferometer block 21 is arranged so as to straddle the TX-PIC 12 and the RX-IC 13. Such an arrangement contributes to miniaturization and cost reduction of the distance measuring device 10, and also makes it possible to keep the optical path length of the measuring system to a minimum and minimize detection performance deterioration due to changes in optical path length due to temperature changes.

The optical interferometer block 21 has a plurality of optical elements including the polarizing beam splitters 213 and 216, the half wave plates 211 and 215, and the quarter wave plate 214, and the gaps 22 between the plurality of optical elements are filled with an optical material that transmits the wavelength of the transmission light. By making beams of multiple pixels incident on a set of optical element blocks, a multi-channel interferometer can be realized at low cost. In addition, it is possible to avoid changes in optical path length due to vibrations or the like, and to minimize deterioration in detection performance.

In the distance measuring device 10, the microlens array 15 can be arranged at least between the optical interferometer block 21 and the TX-PIC 12 and/or between the optical interferometer block 21 and the RX-IC 13. By arranging the microlens array 15 having the microlenses 131 arranged corresponding to the pixel arrangement, 2n arbitrary consecutive grating couplers starting from an even-numbered grating coupler can be operated in parallel. An optical deflection element such as the wedge prism 14 can be arranged between the optical interferometer block 21 and the TX-PIC 12. By arranging the light deflection element, even if the output angle of the grating coupler is not vertical, the output angle can be made vertical and the light can be made vertically incident on the optical interferometer block 21.

### (System Operation Flow)

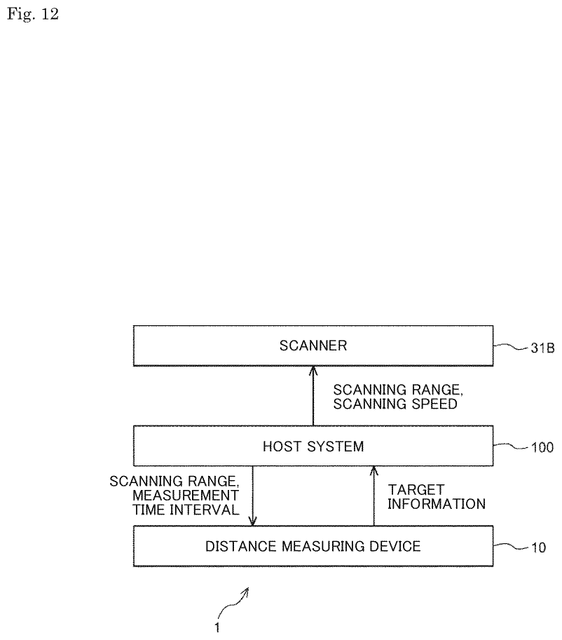

FIG. 12 is a block diagram showing a configuration example of the distance measuring system 1.

In FIG. 12, the distance measuring system 1 includes the distance measuring device 10 including the TX-PIC 12, the RX-IC 13, and the optical interferometer block 21, the external optical system 31 including the scanner 31B, and a host system 100 that controls them.

The host system 100 controls the operation of each device of the distance measuring system 1. The host system 100 sets the scanning range and measurement time interval of the distance measuring device 10. The host system 100 also sets the scanning range and scanning speed of the scanner 31B.

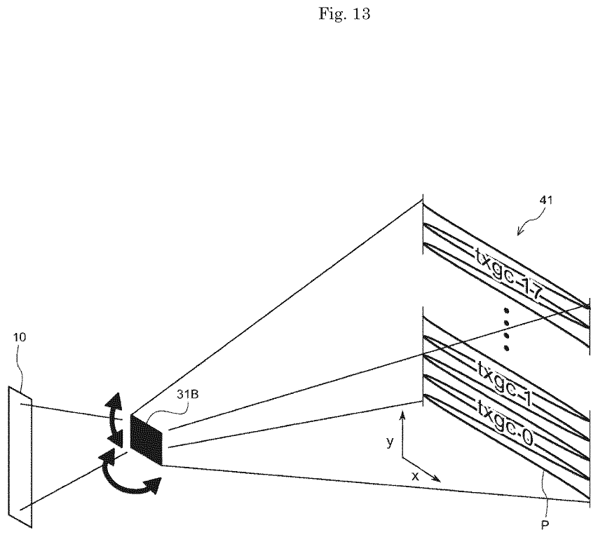

The distance measuring device 10 and the external optical system 31 operate based on information set by the host system 100. As shown in FIG. 13, by combining the distance measuring device 10 having a plurality of pixels (grating couplers) arranged in a predetermined arrangement and the scanner 31B capable of scanning in the 2D directions of the X direction and the Y direction, the scanning pattern P can be drawn on the irradiation surface of the target 41.

The distance measuring device 10 extracts or analyzes target information based on a received signal obtained from a mixed light obtained by mixing reception light which is light reflected from the target 41 and reference light, and outputs the target information to the host system 100. The host system 100 performs predetermined processing based on target information input from the distance measuring device 10.

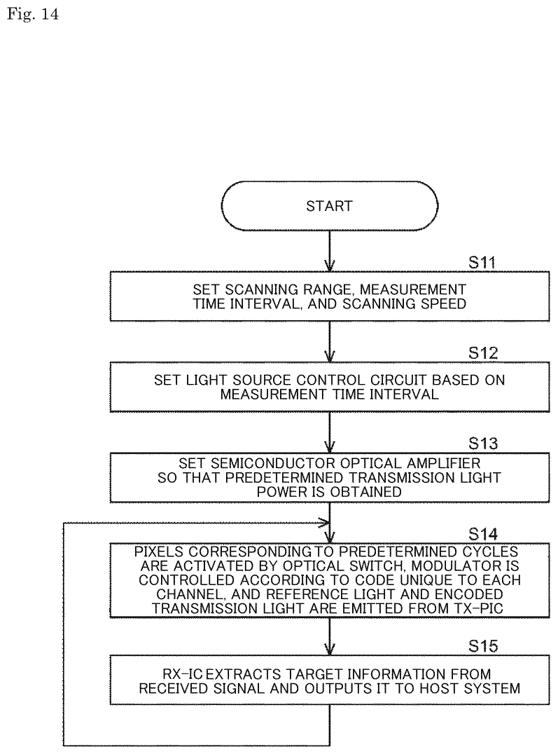

Next, the flow of the operation of the distance measuring system 1 in FIG. 12 will be explained with reference to the flowchart in FIG. 14.

In step S11, the host system 100 sets the scanning range, measurement time interval, and scanning speed. Once these parameters are set, measurements begin.

Specifically, the host system 100 sets the scanning range and measurement time interval of the distance measuring device 10. As the scanning range of the distance measuring device 10, the numbers of grating coupler (GC) and photodiodes (PD) to be activated are set.

The host system 100 also sets the scanning range and scanning speed of the scanner 31B. As the scanning range of the scanner 31B, the scanning ranges in the X direction and the Y direction are set.

In step S12, the host system 100 sets a light source control circuit (not shown) based on the measurement time interval. The light source control circuit is a circuit installed in the distance measuring device 10 and controls the chirp light source 141. The light source control circuit controls the chirp light source 141 so that the chirp-related characteristic values (T_{mod}, T_{code}, f_{bw}, and the like) shown in FIG. 7 become desired values.

The host system 100 waits for a predetermined waiting time to elapse in order to stabilize the light source output according to the characteristics of the chirp light source 141, and then advances the processing from step S12 to step S13.

In step S13, the host system 100 sets the semiconductor optical amplifier 143 to obtain a predetermined transmission optical power. Here, the host system 100 controls the current of the semiconductor optical amplifier 143.

In step S14, the optical switch 144 activates the pixels corresponding to the predetermined cycles shown in FIGS. 9 to 11, and the modulator 146 is controlled according to the code unique to each channel to encode the transmission light. Then, the encoded transmission light is emitted from the TX-PIC 12 together with the reference light. The transmission light from the TX-PIC 12 is irradiated onto the target 41 via the optical interferometer block 21 and the like.

In step S15, the reception light that is light reflected from the target 41 and the reference light are interfered by the optical interferometer block 21 and are received by the differential PD of the RX-IC 13, and the DSP 123 extracts (or analyzes) target information from the received signal. The target information is output to the host system 100.

When one cycle of distance measurement is completed through the processing of steps S14 and S15, the processing returns to step S14, and by activating the pixels corresponding to the next cycle with the optical switch 144, transmission of the transmission light by the TX-PIC 12 and reception of the received signal and distance measurement by the RX-IC 13 are repeated. The scanner 31B scans within the field of view set by the host system 100 in synchronization with this cycle.

Multi-channel coherent LiDAR, which has a large number of channels, is required to suppress crosstalk (interference) between channels. In the present disclosure, the distance measuring device 10 is provided as a multi-channel coherent LiDAR that modulates transmission light with a unique code for each channel for the purpose of suppressing crosstalk between channels.

In the distance measuring device 10, the light source is integrated into the TX-PIC 12 in order to realize a light source section that supports a large number of channels at low cost. In the distance measuring device 10, an optical switch is also integrated into the TX-PIC 12 for encoding the transmission light. In addition, in the distance measuring device 10, the reference light is emitted continuously without being encoded so that the reception light, which is the light reflected from the target 41 irradiated with the encoded transmission light, is reliably mixed with the reference light within the optical interferometer block 21. In the TX-PIC 12, in order to emit only the reference light continuously, the TX GC 112 which is a coupler for transmission light and the LO GC 111 which is a coupler for reference light are provided independently for each channel so that the couplers have independent light exit ports.

On the other hand, PTL 1 discloses a multi-channel coherent LiDAR in which the light source is configured with a photonic integrated circuit (PIC) and the optical interferometer is configured with discrete optical elements, but it has the following problems. That is, a first problem is that countermeasures against crosstalk are insufficient, and a second problem is that the point rate decreases when the scanning range is narrowed.

More specifically, in the multi-channel coherent LiDAR disclosed in PTL 1, a light source with the same optical frequency is used as light sources for the transmission light for multiple channels. Therefore, when transmission light from one channel is reflected by a target and received by another channel, there is a risk that a target that does not actually exist will be erroneously detected, resulting in so-called inter-channel interference (crosstalk). Therefore, countermeasures against crosstalk are not sufficient.

In particular, in-vehicle LiDAR does not need to constantly measure the entire field of view that LiDAR can cover. For example, if the multi-channel coherent LiDAR disclosed in PTL 1 is assumed to be used as an in-vehicle LiDAR for forward monitoring that can cover a field of view of 60° horizontally and 30° vertically, when a vehicle equipped with the LiDAR is driving on a flat, straight road, it is assumed that the vehicle only needs to pay attention to the central part of the field of view, for example, 10° horizontally and 10° vertically. In such a case, only some channels will be enabled and the point rate will drop. Therefore, narrowing down the scanning range will reduce the point rate. Furthermore, there is a problem that redundant hardware when narrowing down the scan range cannot be effectively utilized.

### 2. Modification Example

### (Other Examples of Modulators)

In the above description, intensity modulation including on-off modulation is used to encode transmission light in order to prevent interference, but this is merely an example, and the present invention is not limited to intensity modulation. For example, in the TX-PIC 12, a frequency modulator or a phase modulator can be provided in place of the modulator 146 that performs intensity modulation. Even when using a frequency modulator or a phase modulator, by applying unique modulation to the transmission light for each channel and not modulating the reference light, interference between channels can be reduced by signal processing by the RX-IC 13 as in the case of using the modulator 146.

As for the frequency modulator, for example, an optical single side band (SSB) modulator that modulates the input optical frequency using an RF signal can be used as an example that can be implemented in the TX-PIC 12. The phase modulator can be realized by directly using the phase shifter 161 (FIG. 5) described as a part of the modulator 146 that performs intensity modulation. As described above, the TO phase shifter or the EO phase shifter can be used as the phase shifter 161.

Alternatively, in the TX-PIC 12, the transmission light may be encoded using a combination of multiple modulation methods, such as a combination of intensity modulation and phase modulation, and interference may be similarly removed by signal processing in the RX-IC 13.

### (Other Examples of Pixel Arrays)

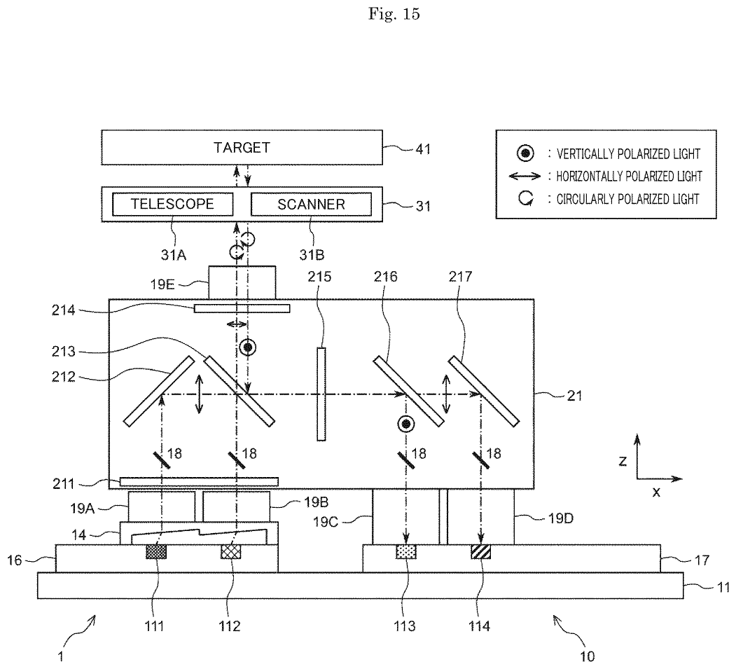

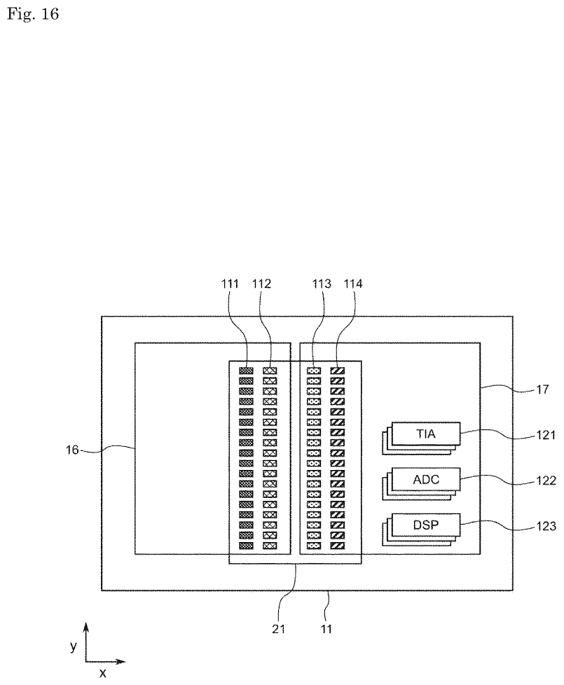

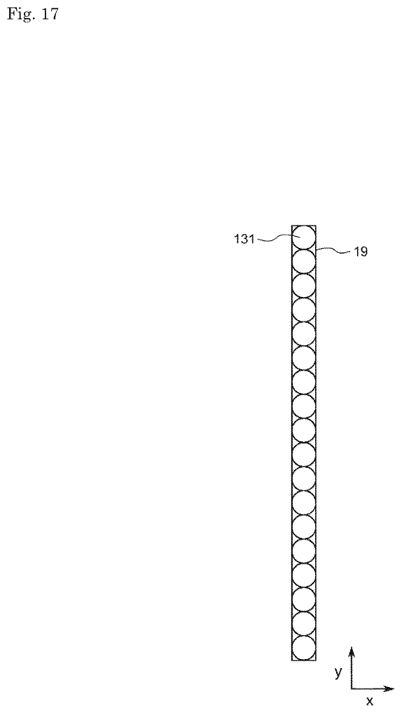

In the above description, the LO GC 111 and TX GC 112 of the TX-PIC 12 and the lower PD 113 and upper PD 114 of the RX-IC 13 are each arranged with an offset of three rows, but other pixel arrangements may be used. FIGS. 15 to 17 show other configuration examples of a distance measuring system to which the present disclosure is applied. FIG. 15 is a cross-sectional view showing another configuration example of the distance measuring device 10 to which the present disclosure is applied. FIG. 16 is a top view showing a configuration example of the distance measuring device 10 of FIG. 15. FIG. 17 is a top view showing a configuration example of a microlens array 19 of FIG. 15.

In FIG. 15, compared to the distance measuring device 10 in FIG. 1, the distance measuring device 10 is provided with a TX-PIC 16 and an RX-IC 17 instead of the TX-PIC 12 and the RX-IC 13. Furthermore, microlens arrays 19A to 19E are provided instead of the microlens arrays 15A to 15E.

Like the TX-PIC 12, the TX-PIC 16 has eighteen LO GCs 111 and eighteen TX GCs 112, but as shown in the top view of FIG. 16, the LO GCs 111 and TX GCs 112 are each arranged in a row. Like the RX-IC 13, the RX-IC 17 has eighteen lower PDs 113 and eighteen upper PDs 114, but as shown in the top view of FIG. 16, the lower PDs 113 and upper PDs 114 are each arranged in a row.

That is, the lower PD 113 and upper PD 114, which are arranged in a row as each pixel of the RX-IC 17, can be arranged at the same Y coordinate as the LO GC 111 and TX GC 112, which are arranged in a row as each pixel of the TX-PIC 16. This allows the light emitted from the grating coupler (GC) and the light reflected from the target 41 to be received by the differential PD corresponding to each pixel.

In the microlens arrays 19A to 19E, as shown in the top view of FIG. 17, eighteen microlenses 131 are arranged in a row corresponding to each pixel of the TX-PIC 16 and RX-IC 17.

In addition, in the cross-sectional views of FIGS. 1 and 15, an example is shown in which the TX-PIC 12 and RX-IC 13, and the TX-PIC 16 and RX-IC 17 are configured as separate chips. However, the TX-PIC and RX-IC are not necessarily separate chips, and may be formed on the same semiconductor substrate.

### (Other Examples of Optical Interferometers)

Although the configuration shown in the cross-sectional view of FIG. 1 is shown as the configuration of the optical interferometer block 21, the configuration is not limited to this, and other configurations that can realize similar detection may be used. For example, a similar interferometer can be realized even when, in the cross-sectional view of FIG. 1, the half wave plate 215 (azimuth angle) 22.5° arranged between the two polarizing beam splitters 213 and 216 is replaced with a quarter wave plate (azimuth angle) 45°. In addition, regarding the polarizing beam splitters 213 and 216, instead of the type that transmits horizontally polarized light and reflects vertically polarized light as shown in the cross-sectional view of FIG. 1, a so-called Wollaston prism or the like that separates both polarized lights at a separation angle of about 20° may be used.

Note that an embodiment of the present disclosure is not limited to that described and can be modified in various manners without departing from the gist of the present disclosure. The advantageous effects described herein are merely exemplary and are not limiting, and other advantageous effects may be exhibited.

In the present specification, a system is a collection of a plurality of constituent elements (devices, modules (components), and the like) and it does not matter whether all the constituent elements are in the same housing. Accordingly, a plurality of devices accommodated in separate housings and connected over a network and a single device in which a plurality of modules are accommodated in one housing both constitute a system. Note that in this specification, “2D” represents two dimensions, and “3D” represents three dimensions.

The present disclosure can be also configured as follows.

(1)

A distance measuring device including:
a photonic integrated circuit that has a function compatible with a coherent LiDAR method that measures distance based on interference between reception light, which is reflected light of transmission light irradiated on a target, and reference light, wherein
the photonic integrated circuit independently includes a first coupler for the transmission light and a second coupler for the reference light as optical couplers that couple the inside and outside of an optical waveguide.
   (2)

The distance measuring device according to (1), wherein the photonic integrated circuit further includes a converter that modulates the transmission light.

(3)

The distance measuring device according to (1) or (2), wherein at least some optical couplers of the first coupler and the second coupler is a grating coupler.

(4)

The distance measuring device according to (3), wherein
the photonic integrated circuit includes a structure in which a plurality of grating couplers arranged in a row are connected by a spiral optical waveguide.
   (5)

The distance measuring device according to any one of (1) to (4), further including:
an optical interferometer block that causes interference between the reception light and the reference light; and
a receiving circuit that receives the interfered reception light and reference light.
   (6)

The distance measuring device according to (5), wherein
the optical interferometer block is arranged so as to straddle the photonic integrated circuit and the receiving circuit.
   (7)

The distance measuring device according to (5) or (6), wherein
the optical interferometer block has a plurality of optical elements including a polarizing beam splitter and a wave plate.
   (8)

The distance measuring device according to (7), wherein
a gap between the plurality of optical elements in the optical interferometer block is filled with an optical material that transmits a wavelength of the transmission light.
   (9)

The distance measuring device according to any one of (5) to (8), wherein a microlens array is disposed at least between the optical interferometer block and the photonic integrated circuit and/or between the optical interferometer block and the receiving circuit.

(10)

The distance measuring device according to any one of (5) to (9), wherein
an optical deflection element is disposed between the optical interferometer block and the photonic integrated circuit.
   (11)

The distance measuring device according to any one of (5) to (10, wherein
the receiving circuit extracts target information regarding the target based on a received signal obtained from the interfered reception light and reference light.
   (12)

A distance measuring system including:
a photonic integrated circuit that has a function compatible with a coherent LiDAR method that measures distance based on interference between reception light, which is reflected light of transmission light irradiated on a target, and reference light; and
an external optical system including a telescope that deflects the transmission light to different emission angles for each pixel and a scanner that can deflect the transmission light from the telescope at least in a direction that intersects an arrangement direction of pixels, wherein
the photonic integrated circuit independently includes a first coupler for the transmission light and a second coupler for the reference light as optical couplers that couple the inside and outside of an optical waveguide.

### REFERENCE SIGNS LIST

1 Distance measuring system
10 Distance measuring device
11 Package substrate
12 TX-PIC
13 RX-IC
14 Wedge prism
15, 15A to 15E Microlens array
16 TX-PIC
17 RX-IC
19, 19A to 19E Microlens array
21 Optical interferometer block
22 Gap
31 External optical system
31A Telescope
31B Scanner
41 Target
100 Host system
111 LO GC
112 TX GC
113 Lower PD
114 Upper PD
121 TIA
122 ADC
123 DSP
131 Microlens
141 Chirp light source
142 Splitter
143 Semiconductor optical amplifier
144 Optical switch
145 LO splitter
146 Modulator
161 Phase shifter
161A Electrode
171 Tapered portion
172 Grating coupler
211 Half wave plate
212 Total reflection mirror
213 Polarizing beam splitter
214 Quarter wave plate
215 Half wave plate
216 Polarizing beam splitter
217 Total reflection mirror

1. A distance measuring device comprising:
a photonic integrated circuit that has a function compatible with a coherent LiDAR method that measures distance based on interference between reception light, which is reflected light of transmission light irradiated on a target, and reference light, wherein
the photonic integrated circuit independently includes a first coupler for the transmission light and a second coupler for the reference light as optical couplers that couple the inside and outside of an optical waveguide.

2. The distance measuring device according to claim 1, wherein
the photonic integrated circuit further includes a converter that modulates the transmission light.

3. The distance measuring device according to claim 1, wherein
at least some optical couplers of the first coupler and the second coupler is a grating coupler.

4. The distance measuring device according to claim 3, wherein
the photonic integrated circuit includes a structure in which a plurality of grating couplers arranged in a row are connected by a spiral optical waveguide.

5. The distance measuring device according to claim 1, further comprising:
an optical interferometer block that causes interference between the reception light and the reference light; and
a receiving circuit that receives the interfered reception light and reference light.

6. The distance measuring device according to claim 5, wherein
the optical interferometer block is arranged so as to straddle the photonic integrated circuit and the receiving circuit.

7. The distance measuring device according to claim 5, wherein
the optical interferometer block has a plurality of optical elements including a polarizing beam splitter and a wave plate.

8. The distance measuring device according to claim 7, wherein
a gap between the plurality of optical elements in the optical interferometer block is filled with an optical material that transmits a wavelength of the transmission light.

9. The distance measuring device according to claim 6, wherein
a microlens array is disposed at least between the optical interferometer block and the photonic integrated circuit and/or between the optical interferometer block and the receiving circuit.

10. The distance measuring device according to claim 6, wherein
an optical deflection element is disposed between the optical interferometer block and the photonic integrated circuit.

11. The distance measuring device according to claim 5, wherein
the receiving circuit extracts target information regarding the target based on a received signal obtained from the interfered reception light and reference light.

12. A distance measuring system comprising:
a photonic integrated circuit that has a function compatible with a coherent LiDAR method that measures distance based on interference between reception light, which is reflected light of transmission light irradiated on a target, and reference light; and
an external optical system including a telescope that deflects the transmission light to different emission angles for each pixel and a scanner that can deflect the transmission light from the telescope at least in a direction that intersects an arrangement direction of pixels, wherein
the photonic integrated circuit independently includes a first coupler for the transmission light and a second coupler for the reference light as optical couplers that couple the inside and outside of an optical waveguide.
